(19) United States
(12) Patent Application Publication
(10) Pub. No.: US 2002/0041756 A1
(43) Pub. Date: Apr. 11, 2002

(54) Data reproduction apparatus that switches reproduction target

(76) Inventor: Takahiro Kato, Okazaki-shi (JP)

Correspondence Address: Joseph W. Price, PRICE and GESS, 2100 S.E. Main Street, Suite 250, Irvine, CA, 92614, US

(21) Appl. No.: 09/973,232

(22) Filed: Oct. 9, 2001

(30) Foreign Application Priority Data
Oct. 11, 2000 (JP) 2000-310391

(51) Int. Cl. H04N 5/76

(52) U.S. Cl. 386/69; 386/95

(57) ABSTRACT

A data reproduction apparatus includes a storage medium and a reproduction unit. The storage medium stores a transport stream that includes location information at a first location thereof, the location information identifying a second location that is on a time axis and that differs from the first location. The second location is included in the transport stream that includes the location information or in a different transport stream. The reproduction unit (a) reproduces video data and/or audio data included in a reference target in the transport stream, while shifting the reference target along a time axis of the transport stream, and (b) switches the reference target to the second location identified by the location information, when the reference target in the transport stream includes the location information.

### BACKGROUND OF THE INVENTION

(1) Field of the Invention

The present invention relates to a reproduction apparatus that reproduces video and audio of digital broadcasts and the like recorded in a data format of transport streams, and particularly to a technique for switching a reproduction target.

(2) Description of the Prior Art

In recent years, data reproduction apparatuses that receive, record, and reproduce program data of digital satellite broadcasts have increasingly been widespread.

Such a data reproduction apparatus receives a transport stream (hereafter simply referred to as a “TS”) that complies with MPEG-2 (Moving Picture Experts Group phase 2) transmitted wirelessly from satellites and the like, demultiplexes and decodes program data of a program desired by a user, out of program data of a plurality of programs multiplexed in the TS, and reproduces video and audio of the desired program in real time. Besides, the data reproduction apparatus is capable of recording the received TS onto a storage medium such as a hard disc, reading recorded data of a program desired by the user from the storage medium to reproduce the desired program.

This enables the user to reproduce and view programs that were being broadcasted simultaneously with the program viewed in real time, at different times.

However, the above data reproduction apparatus has the following problem. When are production instruction is given, the data reproduction apparatus executes the processing identical to that for the above mentioned real-time reproduction, except reading a TS from the storage medium instead of receiving a transmitted TS. Therefore, although channel switching is possible, that is, switching the reproduction target from a presently viewed scene to a scene of another program that was being broadcasted at the same time is possible, switching the reproduction target to a scene of another program that was broadcasted at a different time from the presently viewed scene is not possible.

Also, the TS includes a PAT (Program Association Table) for managing programs. The PAT is referred to by the above data reproduction apparatus to recognize programs that can be reproduced. Since the data reproduction apparatus is unable to refer to a PAT of a different TS that is yet to be read from the storage medium, and so is unable to recognize reproduceable programs in the different TS. Accordingly, the data reproduction apparatus is not capable of switching the reproduction target from a program presently being reproduced in a TS to a program included in a different TS.

To reproduce the program included in the different TS, the data reproduction apparatus should first end reproducing the program in the present TS, reads the different TS from the storage medium, and then start reproducing the program in the read different TS.

As described above, the problem is that once a program in a TS recorded by the data reproduction apparatus starts being reproduced, switchable reproduction targets are limited to scenes of programs that were broadcasted at the same time as the presently reproduced program and that are included in the same TS.

### SUMMARY OF THE INVENTION

In view of the above problem, the first object of the present invention is to provide a data reproduction apparatus with further reduced limitations of switchable reproduction targets during reproduction of programs included in recorded TSs.

Also, the second object of the present invention is to provide a data reproduction method with further reduced limitations of switchable reproduction targets during reproduction of programs included in recorded TSs by the above data reproduction apparatus.

Furthermore, the third object of the present invention is to provide a computer-readable recording medium on which a program is recorded to execute data reproduction with further reduced limitations of switchable reproduction targets during reproduction of programs included in recorded TSs by the above data reproduction apparatus.

The above first object of the present invention can be achieved by a data reproduction apparatus that reproduces data included in transport streams, including: a storage medium storing a first transport stream that includes location information at a first location thereof, the location information identifying a second location that is on a time axis and that differs from the first location, the second location being included in the first transport stream or in a second transport stream; and a reproduction unit for (a) reproducing video data and/or audio data included in a reference target in the first transport stream, while shifting the reference target along a time axis of the first transport stream, and (b) switching the reference target to the second location identified by the location information, when the reference target in the first transport stream includes the location information.

With the above construction, when the reference target includes the location information, the reference target is switched to the second location identified by the location information. Therefore, the data reproduction apparatus with reduced limitations of switchable reproduction targets during reproduction of video or audio, i.e., programs, in recorded TSs is realized.

Also, the storage medium may store the second transport stream that includes the second location, the location information may further include transport stream information that identifies the second transport stream that includes the second location, and the reproduction unit may switch the reference target to the second location in the second transport stream identified by the transport stream information.

With the above construction, the location information further includes transport stream information for identifying the second transport stream. This enables the reference target after the switch to be recognized easily.

Also, each of the first and second transport streams may include data for a plurality of programs with being multiplexed, the location information may further include program ID information that identifies one of the plurality of programs, and there production unit may set, as the reference target, video data and/or audio data that belongs to the program identified by the program ID information and that is present at and following the second location, after switching the reference target.

With the above construction, the location information further includes program ID information that identifies one of the plurality of programs. This enables the reference target program after the switch to be recognized easily.

Also, each of the first and second transport streams may be composed of a plurality of packets and includes a program map table for identifying data that constitutes each program included therein, and a program association table for identifying a packet that carries the program map table, and the location information may be included in the program map table.

With the above construction, the location information is included in a PMT, management information that is highly likely to be referred to. This enables the location information to be detected easily.

Also, the program map table that includes the location information may identify data for the program identified by the program ID information.

With the above construction, a PID of a program to be reproduced after the switch can be obtained in advance. Therefore, data necessary for reproducing the video or the audio can be identified in advance, before the switch and reference to a first PAT and PMT included in the reference target.

Also, the data reproduction apparatus may further include a location information insertion unit for (a) extracting a program map table for identifying the program identified by the program ID information from the second transport stream, (b) adding the location information to the extracted program map table, to generate an insertion program map table, and (c) inserting the generated insertion program map table into a transport stream to generate the first transport stream, wherein the program map table including the location information included in the first transport stream is the insertion program map table that has been inserted by the location information insertion unit.

With the above construction, a PMT of a program to be set as the reproduction target after the switch can be obtained easily.

Also, when inserting the insertion program map table including the location information, the location information insertion unit may (a) delete a program map table of a program to be referred to before switching the reference target, (b) change a value of a packet identifier of the insertion program map table to a value of a packet identifier of the deleted program map table, and (c) change a program number shown in the insertion program map table to a program number shown in the deleted program map table.

With the above construction, when a program corresponding to the deleted PMT is set as the reproduction target before the switch, the transition information can be recognized easily.

More specifically, when a program different from the program corresponding to the deleted PMT is reproduced, the transition information can be prevented from being recognized.

Also, the insertion program map tale may include a program number of the program identified by the program ID information and a packet identifier for identifying a program map table corresponding to the program identified by the program ID information, and the location information insertion unit may further add the program number and the packet identifier to a program association table present in a vicinity preceding a location at which the insertion program map table has been inserted.

With the above construction, the number of programs appears to have been increased. This further reduces the limitations of switchable reproduction targets during reproduction of programs.

Also, the location information insertion unit may, (a) before adding the program number and the packet identifier to the program association table, replace the program number with a unique number, if the program number is already present in the program association table, and replace the value of the packet identifier with a unique value, if the value of the packet identifier is already used in the transport stream into which the insertion program map table is yet to be inserted, and (b) before inserting the insertion program map table, replace the program number included in the insertion program map table with the unique number, if the program number added to the program association table has been replaced with the unique number, and replace the value of the packet identifier included in the insertion program map table with the unique value, if the value of the packet identifier added to the program association table has been replaced with the unique value.

With the above construction, misidentification of data using the program number and the PID can be avoided.

Also, each of the first and second transport streams may be composed of a plurality of packets and includes a program map table for identifying data that constitutes each program included therein, and a program association table for identifying a packet that carries the program map table, and the location information may be included in the program association table.

With the above construction, the location information is included in the PAT, management information that is always referred to. Therefore, the location information can be detected easily.

Also, the transport stream information may be a name of a file that stores the second transport stream in the storage medium.

With the above construction, the transport stream can be identified using the file name as a key.

Also, each of the first and second transport streams may include a packet that carries a program map table for identifying data that constitutes each program included therein, and a program association table for identifying the packet that carries the program map table, and the program ID information may be a program number shown in the program association table and in the program map table.

With the above construction, the reproduction target program can be identified by the program number.

Also, the data reproduction apparatus may further include a location information insertion unit for inserting the location information into a transport stream to generate the first transport stream, wherein the location information included in the first transport stream has been inserted by the location information insertion unit.

With the above construction, the PMT of the reproduction target program after the switch can be obtained easily.

Also, the data reproduction apparatus may further include an insertion location obtaining unit for obtaining the first location and notifying the location information insertion unit of the obtained first location.

With the above construction, the second location can be obtained.

Also, the data reproduction apparatus may further include: a display unit for displaying on a screen a plurality of locations as candidates for the first location; and a reception unit for receiving a specification of one of the plurality of locations, wherein the location information insertion unit inserts the location information into the transport stream at the one of the locations specified as the first location.

With the above construction, the second location can be selected easily.

Also, the location information may further include a mode information indicating one of a manual mode and an automatic mode, the manual mode for switching the reproduction target by a user judgment, the automatic mode for switching the reproduction target without the user judgment, and the reproduction unit may switch the reproduction target based on the mode information.

With the above construction, the switch between reproduction targets can be performed by a user judgment or without the user judgment. This increases the discretion in the switch between reproduction targets.

Also, the reception unit may further receive a specification of one of the manual mode and the automatic mode, and the location information insertion unit inserts the location information provided with the mode information indicating the specified mode.

With the above construction, a mode can be selected easily.

Also, the reception unit may further receive, from the user, a display instruction to display a specification state of the mode, and the display unit may display information associating the location information with the mode when receiving the display instruction.

With the above construction, a mode relating to already inserted location information can be obtained easily.

Also, the data reproduction apparatus may further include: a reception unit for receiving an instruction from a user; and a restoration unit for obtaining, when receiving a restoration instruction to restore the transport stream into which the location information is yet to be inserted, the location information inserted by the location information insertion unit from the first transport stream, and restoring the transport stream into which the location information is yet to be inserted.

With the above construction, even when the location information is mistakenly inserted into the wrong transport stream, the transport stream can be restored to the original state.

Also, the data reproduction apparatus may further include a reception unit for receiving an instruction from a user, wherein the reproduction unit switches the reproduction target only when an instruction to switch the reproduction target from the user is received by the reception unit.

With the above construction, flexible reproduction that satisfies user requests can be performed.

Also, the data reproduction apparatus may further include a display unit for displaying information for having the user input an instruction indicating whether to switch the reproduction target or not, when the reference target includes the location information.

With the above construction, an instruction from the user as to whether the reproduction target is to be changed or not can be given easily.

Also, the data reproduction apparatus may further include a location information insertion unit for inserting the location information into a transport stream to generate the first transport stream, wherein the location information included in the first transport stream has been inserted by the location information insertion unit.

With the above construction, a PMT of a reproduction target program after the switch can be obtained easily.

Also, the data reproduction apparatus may further include: a second location obtaining unit for obtaining the second location on the time axis; and a location information generation unit for generating the location information based on the second location obtained by the second location obtaining unit, wherein the location information included in the first transport stream has been generated by the location information generation unit.

With the above construction, even when the transport stream does not originally include the second location information, the second location information can be added later.

Also, each of the first and second transport streams may be composed of a plurality of packets, and the location information may be a number of packets present between a first packet and a packet at the second location inclusive, in the transport stream.

With the above construction, the second location can be obtained easily by counting the number of packets from the first packet within the transport stream.

Also, the data reproduction apparatus that reproduces data included in data streams, may include: a storage medium storing a first data stream that includes location information at a first location thereof, the location information identifying a second location that is on a time axis and that differs from the first location, the second location being included in the first data stream or in a second data stream; and a reproduction unit for (a) reproducing video data and/or audio data included in a reference target in the first data stream, while shifting the reference target along a time axis of the first data stream, and (c) switching the reference target to the second location identified by the location information, when the reference target in the first data stream includes the location information.

With the above construction, when the reference target includes the location information, the reference target is switched to the second location identified by the location information. Therefore, the data reproduction apparatus with reduced limitations of switchable reproduction targets during reproduction of video or audio, i.e., programs, in recorded TSs is realized.

Also, the above second object of the present invention can be achieved by a data reproduction method for use in a data reproduction apparatus that reproduces data included in transport streams and that includes a storage medium storing a first transport stream that includes location information at a first location thereof, the location information identifying a second location that is on a time axis and that differs from the first location, the second location being included in the first transport stream or in a second transport stream, the data reproduction method including a reproduction step for (a) reproducing video data and/or audio data included in a reference target in the first transport stream, while shifting the reference target along a time axis of the first transport stream, and (b) switching the reference target to the second location identified by the location information, when the reference target in the first transport stream includes the location information.

With the above construction, when the reference target includes the location information, the reference target is switched to the second location identified by the location information. Therefore, the limitations of switchable reproduction targets during reproduction of video or audio, i.e., programs, in recorded TSs can be reduced further.

Also, the third object of the present invention can be achieved by a computer-readable recording medium on which a program for making a data reproduction apparatus reproduce data is recorded, the data reproduction apparatus reproducing data included in transport streams and including a storage medium storing a first transport stream that includes location information at a first location thereof, the location information identifying a second location that is on a time axis and that differs from the first location, the second location being included in the first transport stream or in a second transport stream, the program including a reproduction step for (a) reproducing video data and/or audio data included in a reference target in the first transport stream, while shifting the reference target along a time axis of the first transport stream, and (b) switching the reference target to the second location identified by the location information, when the reference target in the first transport stream includes the location information.

With the above construction, when the reference target includes the location information, the reference target is switched to the second location identified by the location information. Therefore, the limitations of switchable reproduction targets during reproduction of video or audio, i.e., programs, in recorded TSs can be reduced further.

Furthermore, to achieve the above first object of the present invention more easily, the data editing apparatus of the present invention is provided with a data editing apparatus that edits transport streams, including: a storage medium; and an editing unit for (a) editing a transport stream by inserting location information into the transport stream at a first location thereof, the location information identifying a second location that is on a time axis and that differs from the first location, the second location being included in the transport stream into which the location information has been inserted, or in a different transport stream, and (b) storing the edited transport stream into the storage medium.

With the above construction, the location information can be inserted into the transport stream.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a functional block diagram of an accumulated data reproduction apparatus in a first embodiment of the present invention;

FIG. 2 is a functional block diagram showing an internal construction of a first program information extraction unit;

FIG. 3 shows a data structure of a TS on which data editing is yet to be executed and a data structure of the TS on which the data editing has been executed, when a comparison result of a program number comparison unit shows a match in program numbers and a comparison result of a PMT₁₃ PID comparison unit shows a match in PID values;

FIG. 4 shows a detailed data structure of a PAT;

FIG. 5 shows a detailed data structure of a PMT;

FIG. 6 is a flowchart showing a data editing process executed in the accumulated data reproduction apparatus;

FIG. 7 is a flowchart showing processing for transition reproduction;

FIG. 8A shows an example of a screen displayed by a display unit in step S603 in FIG. 6;

FIG. 8B shows an example of a screen displayed by the display unit in step S604 in FIG. 6;

FIG. 9A shows an example of a screen displayed by the display unit in step S607 in FIG. 6;

FIG. 9B shows an example of a screen displayed by the display unit in step S608 in FIG. 6;

FIG. 10A shows an example of a screen for receiving a user instruction when specifications of a location of a transition target scene in a transition target program and a location of a transition source scene in a transition source program are unnecessary;

FIG. 10B shows a reproduction state when the data editing process is executed based on information extracted using a program title as a key;

FIG. 11 shows an input screen for receiving are production target switch instruction for switching the reproduction target to a different program in the same TS, that is, to a different point on the same time axis;

FIG. 12 shows a screen on which buttons are displayed for the user to instruct whether to switch the reproduction target or not;

FIG. 13 shows an example of a screen for receiving a user instruction;

FIG. 14 shows examples of services offered using an accumulated data reproduction apparatus in a second embodiment of the present invention;

FIG. 15 shows examples of services offered using the accumulated data reproduction apparatus in the second embodiment of the present invention;

FIG. 16 shows contents of data editing executed by a program information adjustment unit in a third embodiment of the present invention; and

FIG. 17 shows a location of an originally present PMT(C) and a location of a newly added PMT(d) in a TS(c) on which the data editing process has been executed.

### DESCRIPTION OF THE PREFERRED EMBODIMENTS

<First Embodiment>

The following describes an accumulated data viewing apparatus to which a first embodiment of the present invention relates, with reference to the drawings.

<Construction>

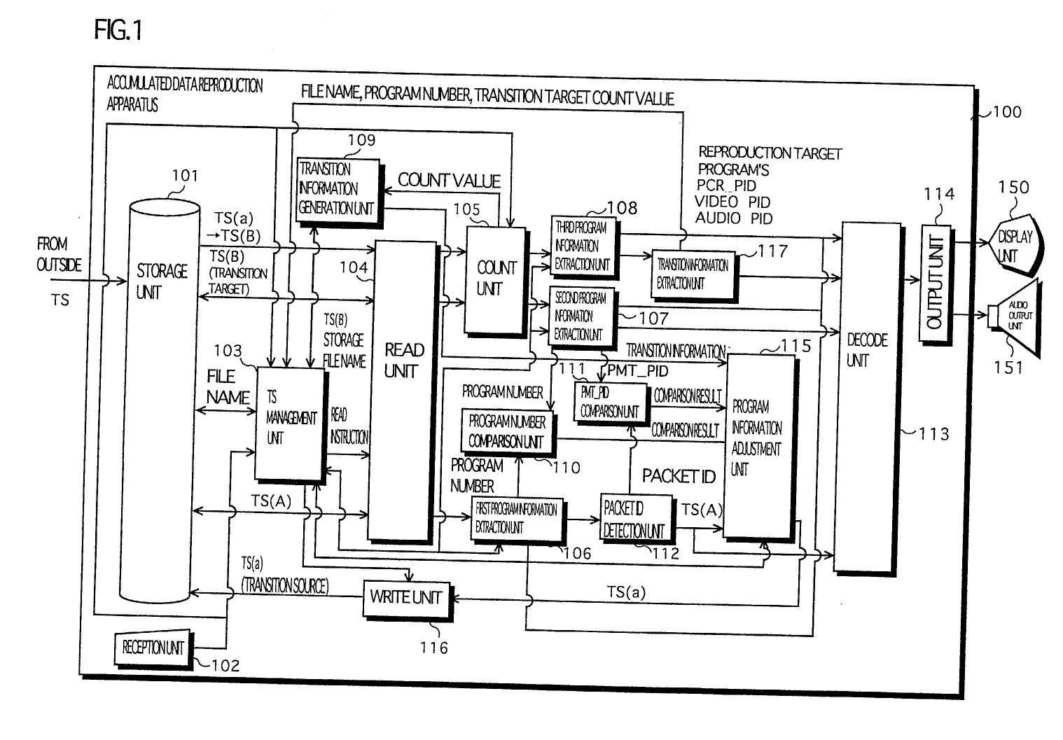

FIG. 1 shows a functional block diagram of an accumulated data reproduction apparatus 100 in the first embodiment of the present invention.

The accumulated data reproduction apparatus 100 records an MPEG-2 compliant TS of digital broadcasts and the like, and reproduces the TS according to a user instruction. The accumulated data reproduction apparatus 100 includes a storage unit 101, a reception unit 102, a TS management unit 103, a read unit 104, a count unit 105, a first program information extraction unit 106, a second program information extraction unit 107, a third program information extraction unit 108, a transition information generation unit 109, a program number comparison unit 110, a PMT_PID comparison unit 111, a packet ID detection unit 112, a decode unit 113, an output unit 114, a program information adjustment unit 115, a write unit 116, and a transition information extraction unit 117.

The functions of the TS management unit 103, the first program information extraction unit 106, the second program information extraction unit 107, the third program information extraction unit 108, the transition information generation unit 109, and the program information adjustment unit 115 are realized by a CPU.

FIG. 1 also shows a display unit 150 and an audio output unit 151. The display unit 150 receives a video signal outputted from the output unit 114 and outputs video. The audio output unit 151 receives an audio signal outputted from the output unit 114 and outputs audio.

The accumulated data reproduction apparatus 100 reproduces one of recorded TSs according to the time flow on a time axis associated with data of each TS, in the same manner as normal reproduction performed at broadcasting.

Furthermore, the accumulated data reproduction apparatus 100 executes data editing within each TS, to realize flexible reproduction that is free from the constraints imposed by the above described time flow, the number of TSs to be reproduced, and the like.

To be more specific, the above flexible reproduction includes a switch, or a transition of the reproduction target, during reproduction of a TS(A) for example, from a program A included in the TS(A) to a program B included in a different TS(B).

The above data editing is preprocessing for enabling this transition (hereafter referred to as a “data editing process”).

The present invention relates to reproduction involving the above mentioned transition (hereafter referred to as “transition reproduction”), and so normal reproduction without involving the transition will not be explained in this specification. The following describes the data editing process and the transition reproduction.

The storage unit 101 is constructed by a storage medium such as a hard disc, and stores a plurality of TSs sent from an external receiving apparatus and the like that receives digital broadcasts.

A TS complies with MPEG-2 (Moving Picture Experts Group phase 2), and includes data that constitutes a plurality of programs, with being multiplexed and stored in packets. In the TS, a PAT that is management information for identifying, each program included in the TS, and a PMT (Program Map Table) that is management information for identifying data that constitutes each program, are inserted at approximately 100 msec intervals on the time axis defined for the TS.

When the TS is stored in the storage unit 101 by an external device, a storage location of the TS within the storage unit 101 and a file name of a file that stores the TS are registered in a management file within the storage unit 101.

The reception unit 102 is an input device constructed by a keyboard, a mouse, or the like. The reception unit 102 receives an input and an instruction from a user, and outputs the received instruction and the like to the TS management unit 103.

To be more specific, the reception unit 102 receives a reproduction instruction, and an execution instruction of the data editing process. Along with this execution instruction of the data editing process, the reception unit 102 further receives user specifications and instruction relating to the transition reproduction, that is, specifications of: a transition target TS; a transition target program in the transition target TS; and a location of a transition target scene in the transition target program, a selection instruction of a transition target, and specifications of: a transition source TS; a transition source program in the transition source TS; and a location of a transition source scene in the transition source program. The reception unit 102 then outputs the received specifications and instruction to the TS management unit 103.

Also, the reception unit 102 outputs a scene specification signal to the TS management unit 103, when receiving a scene of a program that is presently being displayed by the display unit 150.

The TS management unit 103 provides not only control over reading and writing of a TS stored in the storage unit 101 but also control relating to the data editing process and the transition reproduction of data included in the TS.

To be more specific, when the execution instruction of the data editing process is sent from the reception unit 102, the TS management unit 103 receives the above listed specifications sent along with this execution instruction, and executes processing in accordance with each received specification.

When a transition target TS, a TS(B) for example, is specified in the transition reproduction, the TS management unit 103 obtains a storage location of the TS(B) within the storage unit 101 by referring to the management file in the storage unit 101. The TS management unit 103 then outputs a read signal that instructs to start reading data of the TS(B) and the obtained storage location to the read unit 104. Here, the TS management unit 103 outputs the read signal to the count unit 105 as well.

When a transition target program is specified, the TS management unit 103 outputs a program number of this program to the second program information extraction unit 107.

When a location of a transition target scene in the transition target program is specified, the TS management unit 103 outputs a transition target location determination signal to the count unit 105 and to the second program extraction unit 107.

As a result of the transition target location determination signal outputted to the count unit 105, the TS management unit 103 obtains transition information which will be described later from the transition information generation unit 109, and instructs the write unit 116 to store the obtained transition information into the storage unit 101.

When a selection instruction to select a transition target is given, the TS management unit 103 instructs the transition information generation unit 109 to output transition information that indicates the selected transition target, stored within the transition information generation unit 109, to the program information adjustment unit 115. Also, the TS management unit 103 instructs the second program information extraction unit 107 to output a program number and a PID (Packet Identifier) value of a PMT that was stored in the second program information adjustment unit 107 when the transition target location determination signal that had triggered generation of this transition information was inputted, respectively to the program number comparison unit 110 and to the PMT_PID comparison unit 111.

Also, upon receipt of a specification of a transition source TS in the transition reproduction, a TS(A) for example, the TS management unit 103 obtains a storage location of the TS(A) in the storage unit 101 by referring to the management file in the storage unit 101. The TS management unit 103 then outputs a read signal that instructs to start reading data of the TS(A) and the obtained storage location to the read unit 104.

Following this, when a transition source program is specified, the TS management unit 103 outputs a program number of the transition source program to the first program information extraction unit 106.

Following this, a location of a transition source scene in the transition source program is specified, and a location of a transition target scene is specified. The TS management unit 103 then outputs an editing instruction signal to the program information adjustment unit 115.

Here, it is assumed that the specification of the location of the transition source scene in the transition target program and the selection instruction of the transition target are made prior to the specification of the location of the transition source scene in the transition source program.

When receiving a file name of a file that stores a TS, a program number, and a count value from the transition information extraction unit 117, the TS management unit 103 immediately instructs the read unit 104 to start reading data of a packet identified using the count value and the following packets in the TS stored in the file identified by this file name. Also, the TS management unit 103 outputs the received program number to the third program information extraction unit 108.

The read unit 104 receives the storage location of the TS to be read within the storage unit 101 from the TS management unit 103, reads the TS from the storage unit 101, and outputs the read TS to the first program information extraction unit 106 or to the count unit 105.

To be more specific, when the read TS is the TS(A) on which the data editing process is yet to be executed as one example, that is to say, when the read TS is a transition source TS, the read unit 104 outputs this TS(A) to the first program information extraction unit 106. When the read TS is the TS(B) that is a transition target TS, or a TS(a) that is an edited TS obtained by executing the data editing process on the TS(A), the read unit 104 outputs the read TS to the count unit 105.

The count unit 105 is a circuit that counts the number of data packets included in a TS sent from the read unit 104.

To be more specific, the count unit 105 sequentially receives TS data, i.e., packets, sent from the read unit 104. As to each received packet, when the data editing process is to be executed, the count unit 105 outputs the packet to the second program information extraction unit 107, or when the transition reproduction is to be executed, the count unit 105 outputs the packet to the third program information extraction unit 107. Upon receipt of each packet, the count unit 105 increments the count value by one.

Here, the count unit 105 resets the count value to “0” upon receipt of a read signal sent from the TS management unit 103.

Also, in the data editing process, if the count unit 105 receives a transition target location determination signal from the TS management unit 103 while receiving the TS, the count unit 105 outputs the count value at that point, to the transition information generation unit 109.

The first program information extraction unit 106 has the function of extracting a PAT and a PMT included in a TS and extracting program information contained in the extracted PAT and PMT.

To be more specific, the first program information extraction unit 106 receives TS data, i.e., packets, sent from the read unit 104, extracts a PAT and a PMT in the packets, and outputs the received packets to the packet ID detection unit 112.

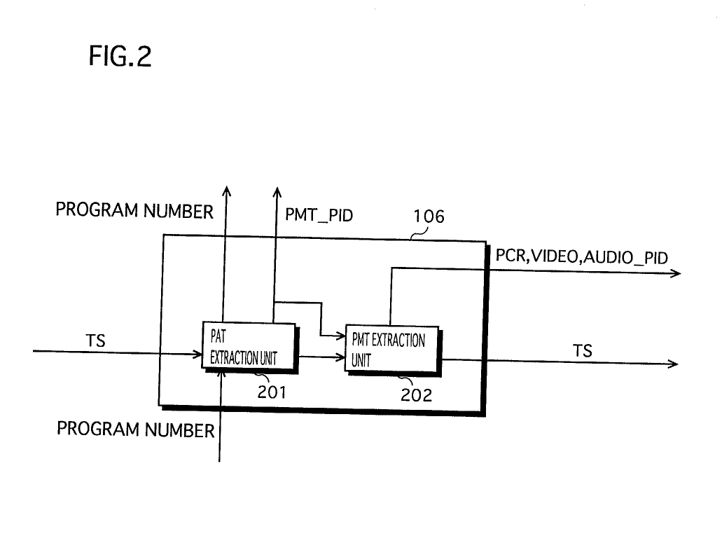

FIG. 2 is a functional block diagram showing the internal construction of the first program information extraction unit 106.

In more detail, the PAT extraction unit 201 extracts a packet whose packet header includes a PID value “0”, i.e., a packet that carries a PAT, out of sent packets included in a TS, and obtains the number of programs included in the TS and a program number associated with each program to identify the program.

Also, the PAT is provided with a version number. This version number is updated every time the contents of the PAT and PMT are updated.

Furthermore, the PAT includes a PID of a PMT corresponding to each program included in the TS.

Therefore, by obtaining the PID of the PMT corresponding to each program, a PMT of a targeted program can be obtained.

The PMT extraction unit 202 receives the PID of the PMT from the PAT extraction unit 201, and extracts a packet that includes this PID, i.e., a packet that carries the PMT.

The extracted PMT is a table that lists identifiers, i.e., PIDs, for identifying data that constitutes a program.

The above extraction of the PAT and the PMT will not be explained in more detail here since it is a well-known technique.

The first program information extraction unit 106 has the function of outputting information obtained from the extracted PAT and PMT, such as a PID of a PCR (Program Clock Reference), a PID of video data, and a PID of audio data, to the decode unit 113.

Also, the first program information extraction unit 106 outputs all program numbers shown in the PAT of the TS received from the read unit 104, to the program number comparison unit 110.

The second program information extraction unit 107 has approximately the same function as the above described first program information extraction unit 106, with the only difference being in the following points.

Firstly, the second program information extraction unit 107 differs from the first program information extraction unit 106 in that it stores a program number received from the TS management unit 103, i.e., a program number of a transition target program, a PID value of a PMT corresponding to the transition target program, and the PMT itself, into an internal storage medium such as a nonvolatile memory. Also, the second program information extraction unit 107 outputs the program number of the transition target program to the program number comparison unit 110 in accordance with an instruction given by the TS management unit 103, and outputs the PID value of the PMT corresponding to the transition target program and the PMT itself, to the PMT_PID comparison unit 111.

Secondly, the second program information extraction unit 107 differs from the first program information extraction unit 106 in that it receives packets of the transition target program from the count unit 105 instead of from the read unit 104, and in that the packets received from the count unit 105 are outputted to the decode unit 113 instead of to the packet ID detection unit 112.

The third program information extraction unit 108 has the function of extracting PIDs that identify data, i.e., packets, necessary for reproducing the reproduction target program and outputting the extracted PIDs to the decode unit 113.

In more detail, to extract the PIDs that identify the packets necessary for reproducing the reproduction target, the third program information extraction unit 108 extracts a PAT included in packets received from the count unit 105.

The third program information extraction unit 108 then receives a program number of the reproduction target program from the TS management unit 103, extracts a PMT corresponding to the reproduction target program identified by this program number from the above packet, obtains PIDs of packets in each of which data that constitutes this program is stored, and outputs the obtained PIDs to the decode unit 113.

Furthermore, the third program information extraction unit 108 has the function of outputting a packet from which a PAT and a PMT have been extracted, to the transition information extraction unit 117.

Note here that the “extraction” referred to herein means obtaining target data by copying the data, and it does not mean changing the structure or the content of the obtained data.

The transition information generation unit 109 is provided with a storage medium such as a nonvolatile memory, and has the function of generating transition information for linking a program in the transition target TS(B) and a program in the transition source TS(A) in the transition reproduction.

To be more specific, the transition information generation unit 109 stores the following three items as one set of transition information into the above storage medium.

The first item is a count value sent form the count unit 105, and is used as information that identifies a transition target in the transition reproduction (hereafter referred to as a “transition target count value”).

The second item is a file name of a file that stores a transition target TS for which the above counting has been performed, and is obtained by the TS management unit 103.

The third item is a program number that identifies a reproduction target program in the transition target TS, and is obtained by the TS management unit 103.

The program number comparison unit 110 is a circuit that compares values and judges whether they match or not, and if they match, generates a unique value that does not match other values.

To be more specific, the program number comparison unit 110 compares (a) one or more program numbers received from the first program information extraction unit 106 with (b) the program number of the transition target program received from the second program information extraction unit 107. If the program number comparison unit 110 finds any of the program numbers that matches the program number of the transition target program, the program number comparison unit 110 generates a unique number that is different from any of the program numbers received from the first program information extraction unit 106, and outputs the generated number as a comparison result, to the program information adjustment unit 115.

On the other hand, if the program number comparison unit 110 does not find any number that matches the program number of the transition target program, the program number comparison unit 110 outputs the program number of the transition target program as the comparison result, to the program information adjustment unit 115.

The PMT_PID comparison unit 111 is a circuit that compares values and judges whether they match or not, and if they match, generates a unique value that does not match other values, as the program number comparison unit 110.

To be more specific, the PMT_PID comparison unit 111 compares (a) the PID value of the PMT that corresponds to the transition target program received from the second program information extraction unit 107 with (b) PID values received from the packet ID detection unit 112. If the PMT_PID comparison unit 111 finds any of the PID values that matches the PID value corresponding to the transition target program, the PMT_PID comparison unit 111 generates a unique value that is different from any of the PID values received from the packet ID detection unit 112, and outputs the generated value as a comparison result, along with the received PMT, to the program information adjustment unit 115.

On the other hand, if the PMT_PID comparison unit 111 does not find any PID value that matches the PID value corresponding to the transition target program, the PMT_PID comparison unit 111 outputs the PID value corresponding to the transition target program as the comparison result, along with the PMT received from the second program information extraction unit 107, to the program information adjustment unit 115.

The packet ID detection unit 112 sequentially refers to packet headers of packets sent from the first program information extraction unit 106, and outputs PID values shown in the packet headers to the PMT_PID comparison unit 111, and at the same time outputs the packets received from the first program information extraction unit 106, to the program information adjustment unit 115.

The decode unit 113 has the function of decoding a video signal, an audio signal, and the like which are coded by the MPEG-2.

To be more specific, the decode unit 113 decodes only data necessary for reproducing a program, based on a PID of a PCR, a PID of audio data, a PID of audio data, and the like, which are sent from one of the first program information extraction unit 106, the second program information extraction unit 107, and the third program information extraction unit 108. The decode unit 113 then outputs a video signal and an audio signal resulting from the decoding, to the output unit 114.

The output unit 114 is a circuit that performs the D/A conversion on the video signal and the audio signal and then outputs the video signal to the display unit 150 and the audio signal to the audio output unit 151.

The program information adjustment unit 115 has the function of inserting transition information used for transiting the reproduction target from a program in a transition source TS to a program in a transition target TS, into the transition source TS at a location where this transition is to be performed.

To be more specific, suppose that in the transition reproduction, the program information adjustment unit 115 is sequentially receiving packets of the transition source TS(A) from the packet ID detection unit 112. Here, upon receipt of an editing instruction signal sent from the TS management unit 103, the program information adjustment unit 115 updates the first to third PATs sent after the input of the editing instruction signal in the following way.

Firstly, the program information adjustment unit 115 adds the above program number and the PID value of the PMT received as the comparison results, within each of the first to third PATs, and updates the version number included in each of the first to third PATs.

The program number and the PID value added here correspond to the program number of the transition target program and the PID value of the PMT of the transition target program.

Secondly, the program information adjustment unit 115 generates a “transition PMT” as follows. The program information adjustment unit 115 (1) adjusts a PID value stored in a packet header of the PMT received from the PMT_PID comparison unit 111 to the PID value received as the above comparison result, and (2) adjusts a program number shown in a payload of this PMT to the program number received as the above comparison result. The program information adjustment unit 115 (3) adds the transition information received from the transition information generation unit 109 to the payload of this PMT, to complete the transition PMT.

The program information adjustment unit 115 inserts the generated transition PMT in a close vicinity following each of the above PATs.

With the above PATs being updated in this way, one program appears to have been added to the TS(A) in view of the TS in the normal broadcasting, but actually, data that constitutes the added program is not being included in the TS(A).

The write unit 116 has the function of writing data of the TS to the storage unit 101 in accordance with an instruction given by the TS management unit 103.

The transition information extraction unit 117 is a circuit that detects a packet in which transition information is stored.

To be more specific, the transition information extraction unit 117 first refers to a version number shown in a PAT. When the version number is being updated, the transition information extraction unit 117 refers to all PMTs that follow this PAT and judges whether transition information is included in these PMTs.

When a PMT that corresponds to the reproduction target program includes the transition information, the transition information extraction unit 117 outputs a file name of a file that stores the TS and a program number shown by this transition information, and outputs a count value shown by the transition information, that is, the transition target count value, to the TS management unit 103.

<Data>

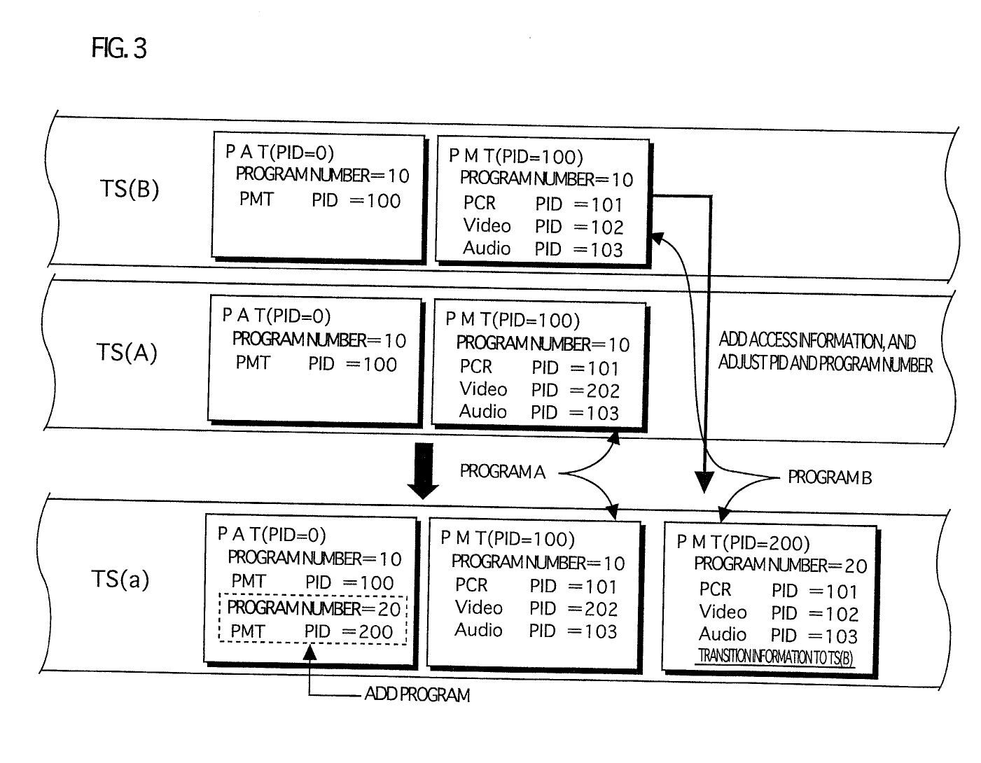

FIG. 3 shows a data structure of a TS on which data editing is yet to be executed in the above described, and a data structure of the TS on which the data editing has been executed, when the comparison result of the program number comparison unit 110 shows a match in program numbers and the comparison result of the PMT_PID comparison unit 111 shows a match in PID values.

Here, the TS(A) is a transition source TS in the transition reproduction, and the TS(B) is a transition target TS in the transition reproduction. Also, the TS(a) is an edited TS obtained by editing the management information of the TS(A) for the transition reproduction.

A PAT and a PMT that are management information for each TS are inserted at approximately 100 msec intervals on the time axis defined for the TS.

For the TS(A), data for only one program is being multiplexed. As one example, the PAT of the TS(A) includes a program number “10” of this program, and a value of an identifier that is stored in a header of a packet that carries the PMT of this program, i.e., a PID value “100” of the PMT.

Also, as one example, the PMT of the TS(A) includes a PID value “100” in its packet header. In its payload, the PMT of the TS(A) includes a program number “10”, a PID value “101” of a packet that stores a PCR that is time information necessary for reproducing video and audio of this program, a PID value “202” of a packet that stores video data of this program, and a PID value “103” of a packet that stores audio data of this program.

For the TS(B), too, data for only one program is being multiplexed. As one example, the PAT of the TS(B) includes a program number “10” of this program, and a value of an identifier that is stored in a header of a packet that carries the PMT of this program, i.e., a PID value “100” of the PMT.

Also, as one example, the PMT of the TS(B) includes a PID value “100” in its packet header. In its payload, the PMT of the TS(B) includes a program number “10”, a PID value “101” of a packet that stores a PCR that is time information necessary for reproducing video and audio of this program, a PID value “102” of a packet that stores video data of this program, and a PID value “103” of a packet that stores audio data of this program.

In this way, the program numbers and the PID values of the PMTs shown by the PATs of the TS(A) and the TS(B) respectively match, and the PID values of the PCRs and the PID values of the audio data shown by the PMTs respectively match.

Here, the data editing process being executed on the TS(A) by the program information adjustment unit 113 results in the edited TS(a).

To be more specific, firstly, the PAT content of the TS(B) is added to the PAT of the TS(A).

Here, the PAT content of the TS(B) to be added to the PAT of the TS(A), that is, the program number and the PID value of the PMT, are values that have already been used in the PAT of the TS(A). To enable the TS management unit 103, the first program information extraction unit 106, the second program information extraction unit 107, and the third program information extraction unit 108 to identify the program originally present in the TS(A) and the program originally present in the TS(B), the program number and the PID value of the PMT of the TS(B) to be added to the TS(A) are changed to a unique number and a unique value.

Secondly, the PMT of the TS(B) is inserted into the TS(A) so as to follow the PAT to which the content of the PAT of the TS(B) has been added.

Here, the program number “10” and the PID value “100” of the PMT of the TS(B) to be inserted into the TS(A) are values that have already been used in the TS(A). These values are also changed to the unique program number “20” and the unique PID value “200”, along with the above described change of the program number and the PID value in the PAT.

Note here that the inserted PMT includes transition information for identifying a transition target in the TS(B). The transition information includes three items: a file name of a file that stores the TS(B); a count value that identifies the first packet of the TS(B); and a program number of a program to be reproduced after the transition in the transition reproduction.

As described above, the PMT of the transition target program is inserted into the transition source TS, so that data that would be necessary for reproduction after the transition can be recognized and extracted, before referring to the PAT firstly extracted after the transition.

Note that the above count value that identifies the first packet of the TS(B) indicates a reproduction start location on the time axis for the TS(B).

The data editing described above is executed not only at one location, namely, on the PAT in the vicinity where the transition reproduction of the TS(A) is to be started, but also on two PATs following the PAT.

Also, the PMT is inserted in a close vicinity following each of the above three PATs.

This is because of the following reason. The accumulated data reproduction apparatus 100 usually refers to all the PATs. However, this referring to all the PATs is not necessarily ensured. It might be possible for the accumulated data reproduction apparatus 100 to skip reading one of them. In view of this possibility, although it may be redundant, the above described update is performed on a plurality of PATs, and a plurality of PMTs are inserted. This ensures that the accumulated data reproduction apparatus 100 refers to the updated PAT and the inserted PMT.

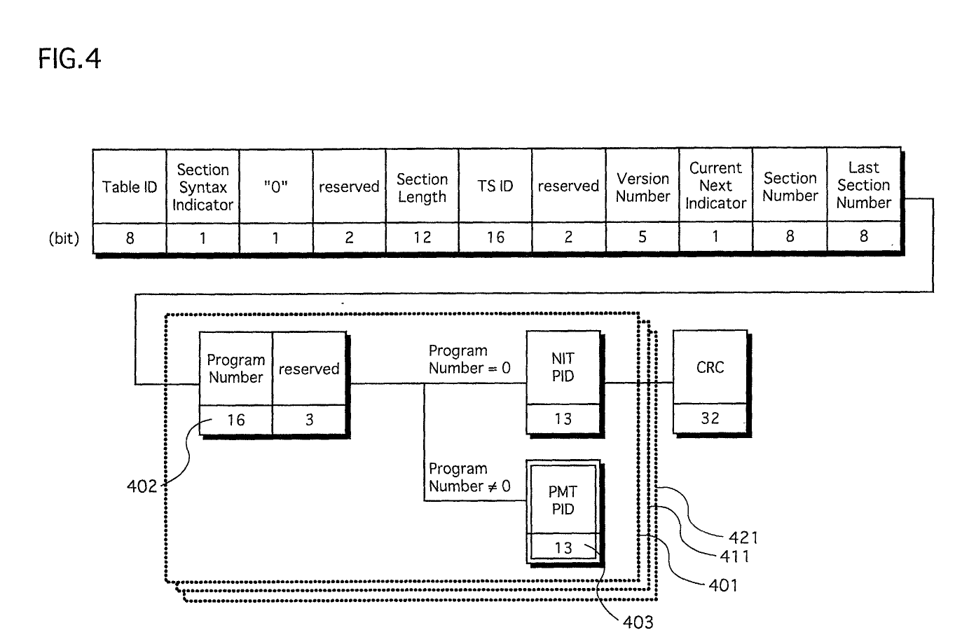

FIG. 4 shows a detailed data structure of a PAT.

This PAT has the same data structure as a PAT defined by the ISO/IEC 13818-1 specification, and so will not be explained in detail here.

The PAT is composed of data in a bit sequence that stores values defined by the above specification, and includes a 16-bit region 402 for storing a program number and a 13-bit region 403 for storing a PID value of a PMT.

Also, data storage regions that each are larger than the region 402 and the region 403 altogether, so-called program information loops 401, 411, and 421 are provided. The number of the provided program information loops corresponds to the number of programs.

In the data editing process, the program information adjustment unit 115 adds a program information loop of the TS(A). To this program information loop, the program information adjustment unit 115 adds a program number of a transition target program in the TS(B) and a PID value of a PMT.

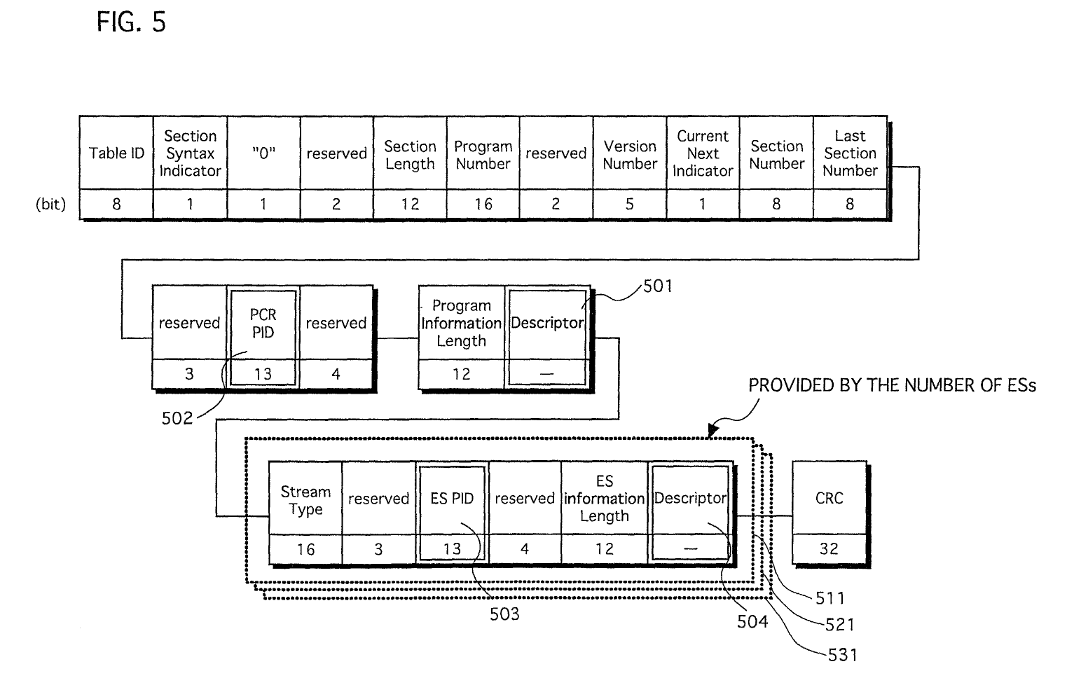

FIG. 5 shows a detailed data structure of a PMT.

The PMT has the same data structure as a PMT defined by the ISO/IEC 13818-1 specification as is the case with the PAT, and so will not be explained in detail here.

The PMT is composed of data in a bit sequence that stores values defined by the above specification, and includes a 13-bit region 502 for storing a PID of a PCR and a 1^{st} loop descriptor field 501 that is a user-definable data region.

In the data editing process, the program information adjustment unit 115 stores the transition information into the above 1^{st} loop descriptor field 501.

<Operations>

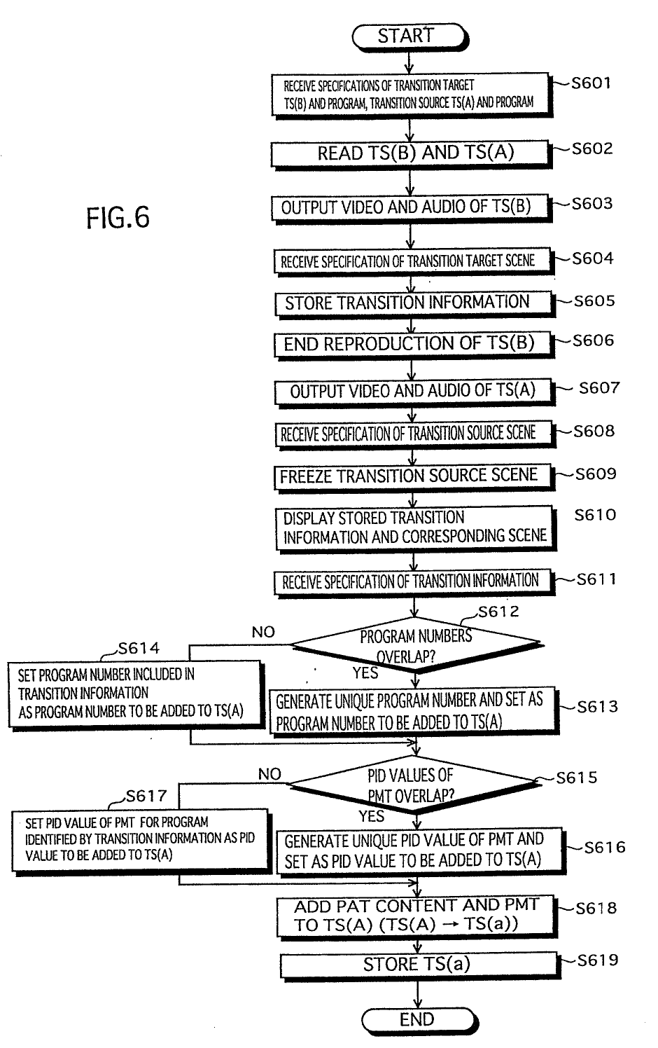

FIG. 6 is a flowchart showing the data editing process executed in the accumulated data reproduction apparatus 100.

The reception unit 102 receives, for example, specifications of: a transition target TS(B); a transition target program; a transition source TS(A); and a transition source program in the transition reproduction (step S601), and outputs these specifications to the TS management unit 103.

The TS management unit 103 instructs the read unit 104 to read the transition target TS(B) and the transition source TS(A) (step S602).

The TS management unit 103 first outputs a program number of the transition target program in the transition target TS(B) and a reproduction instruction of this program to the second program information extraction unit 107. As a result of this, data of this program including video and audio is decoded by the decode unit 113, and the decoded data is outputted via the output unit 114. Specifically, the video is outputted by the display unit 150 and the audio is outputted by the audio output unit 151 (step S603).

When the user finds, in the transition target TS(B), a scene he or she desires to reproduce firstly after the transition, the user performs a key operation for specifying a transition target location via the reception unit 102 while this scene is being displayed.

This results in the reception unit 102 receiving the specification of the location at which the transition target scene is present in the transition target program in the transition target TS(B). The reception unit 102 then outputs a signal that indicates this specification to the TS management unit 103 (step S604).

The TS management unit 103, which has received this signal, outputs a transition target location determination signal to the count unit 105. As a result of this, the count unit 105 outputs a count value that identifies the scene location, to the transition information generation unit 109.

Upon receipt of this count value, the transition information generation unit 109 obtains a file name of a file that stores the TS(B) and a program number of a program that is presently being reproduced in the TS(B) from the TS management unit 103. The transition information generation unit 109 then stores the obtained file name and the program number along with the above count value, into an internal nonvolatile memory (step S605).

Following this, when the reception unit 102 receives a reproduction end instruction, the TS management unit 103 instructs the second program information extraction unit 107 and the decode unit 113 to end reproduction of the program in the TS(B), so that the reproduction ends (step S606).

The TS management unit 103 then outputs a program number of the transition source program in the TS(A) and a reproduction instruction of this program to the first program information extraction unit 106. As a result of this, data of this program including video and audio is decoded by the decode unit 113, and the decoded data is outputted via the output unit 114. Specifically, the video is outputted by the display unit 150 and the audio is outputted by the audio output unit 151 (step S607).

When the user finds a scene he or she desires to start the transition, the user performs a key operation for specifying a transition source location via the reception unit 102 while this scene is being displayed.

This results in the reception unit 102 receiving the specification of the location at which the transition source scene is present in the transition source program in the transition source TS(A) (step S608). The reception unit 102 then outputs a signal that indicates this specification to the TS management unit 103.

The TS management unit 103, which has received this signal, instructs the first program information extraction unit 106 and the decode unit 113 to freeze video and audio that are presently being reproduced, so that the display unit 150 displays a still image of the scene, and the audio output unit 151 suspends to output the audio (step S609).

The TS management unit 103 then executes processing for determining one of the presently generated set of transition information and previously generated sets of transition information, as transition information to identify a transition target from the TS(A).

To be specific, the TS management unit 103 makes the display unit 150 display all sets of transition information stored in the transition information generation unit 109, that is, all sets of a file name, a program number, and a count value stored in the transition information generation unit 109 and a transition target scene corresponding to each set (step S610), and receives a specification of one of the sets of transition information via the reception unit 102 (step S611).

Upon receipt of the specification of the transition information, the TS management unit 103 instructs the second program information extraction unit 107 to output a program number of a transition target program shown by the transition information, a PID value of a PMT corresponding to the transition target program, and the PMT itself. Also, the TS management unit 103 outputs an editing instruction signal to the program information adjustment unit 115.

In response to this, the program number comparison unit 110 judges whether the program number of the transition target program matches any program number shown by each PAT included in the transition source TS(step S612). If the program number comparison unit 110 finds a match, the program number comparison unit 110 generates a unique program number, and sets the generated unique program number as a program number to be added to the TS(A) (step S613), and notifies the program information adjustment unit 115 of this program number.

On the other hand, if the program number comparison unit 110 finds no match, the program number comparison unit 110 sets the program number of the transition target program as the program number to be added to the TS(A) (step S614), and notifies the program information adjustment unit 115 of this program number.

The PMT_PID comparison unit 111 judges whether (a) a PID value of a PMT corresponding to the transition target received from the second program information extraction unit 107 and (b) PID values received from the packet ID detection unit 112 match or not (step S615). If finding a match, the PMT_PID comparison unit 111 generates a unique PID value and sets the generated unique PID value as a PID value of a PMT to be added to the TS(A) (step S616).

On the other hand, if finding no match in the PID values of the PMTs, the PMT_PID comparison unit 111 sets the PID value of the PMT corresponding to the transition target program received by the second program information extraction unit 107 as the PID value of the PMT to be added to the TS(A) (step S617), and notifies the program information adjustment unit 115 of this value.

The program information adjustment unit 115 then adds a pair of the program number and the PID value of the PMT determined to be added to the TS(A), to a PAT located in a vicinity of the specified scene and to the following two PATs in the TS(A).

Also, the program information adjustment unit 115 inserts a transition PMT so as to follow each of the above three PATs. To generate this transition PMT, the program information adjustment unit 115 (1) adjusts a PID value in a packet header of a packet that carries the PMT corresponding to the transition target program in the TS(B) to the PID value of the PMT to be added to the TS(A), (2) adjusts a program number shown in a payload to the program number to be added to the TS(A), and (3) stores the specified transition information into the 1^{st} loop descriptor field of the PMT (step S618).

The TS management unit 103 instructs the write unit 116 to store the TS(a) obtained by editing the TS(A), that is, by adding the above content to the PAT and inserting the transition PMT to the TS(A) as described above, into the storage unit 101. This results in the TS(a) being stored (step S619).

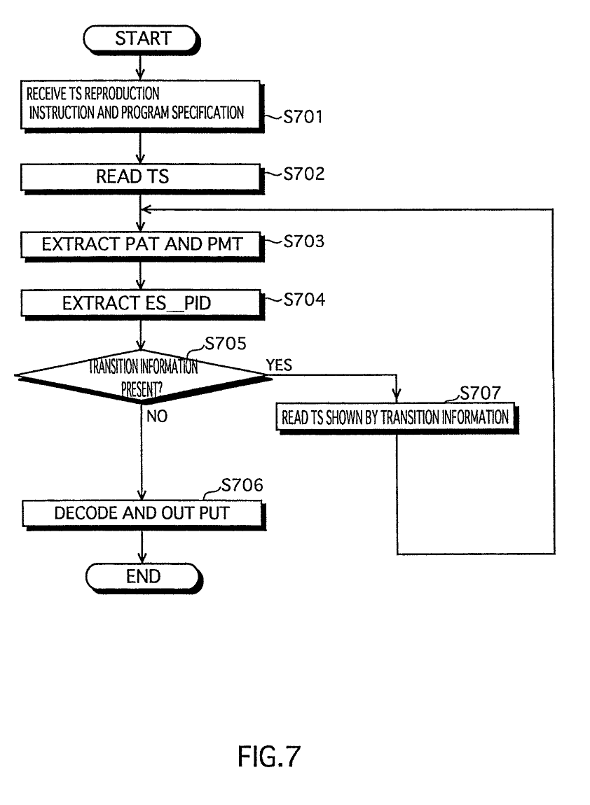

FIG. 7 is a flowchart showing processing for the transition reproduction.

The reception unit 102 receives a reproduction instruction of the TS(a) for example, and a specification of a reproduction target program, and outputs the received instruction and specification to the TS management unit 103 (step S701).

On receipt of the reproduction instruction of the TS(a) and the specification of the reproduction target program, the TS management unit 103 instructs the read unit 104 to read the TS(a), and outputs a program number of the reproduction target program to the third program information extraction unit 108.

As a result of this, the read TS(a) is outputted from the storage unit 101 to the read unit 104, from the read unit 104 to the count unit 105, and from the count unit 105 to the third program information extraction unit 108 sequentially in the stated order (step S702).

The third program information extraction unit 108 then extracts a PAT and a PMT (step S703). The third program information extraction unit 108 further extracts PIDs of packets that respectively store a PCR, video, and audio (hereafter, “ES_PIDs”) from the extracted PMT (step S704). The third program information extraction unit 108 then outputs the received TS(a) to the transition information extraction unit 117.

The transition information extraction unit 117 judges whether transition information is present within the PMT of the received TS(a) (step S705).

When judging that the transition information is not present, the transition information extraction unit 117 outputs the data as it is, to the decode unit 113, so that normal reproduction is performed (step S706).

When judging that the transition information is present, the transition information extraction unit 117 outputs a file, name, a program number, and a transition target count value included in the transition information to the management unit 103.

The TS management unit 103 instructs the read unit 104 to read data of a packet identified by the above transition target count value and the following packets in the TS(B) for example, in a file identified by the received file name. The TS management unit 103 also outputs the received program number to the third program information extraction unit 108.

As a result of this, the TS(B) is read by the read unit 104 (step S707), and the processing returns to step S703 where a PAT and a PMT are extracted.

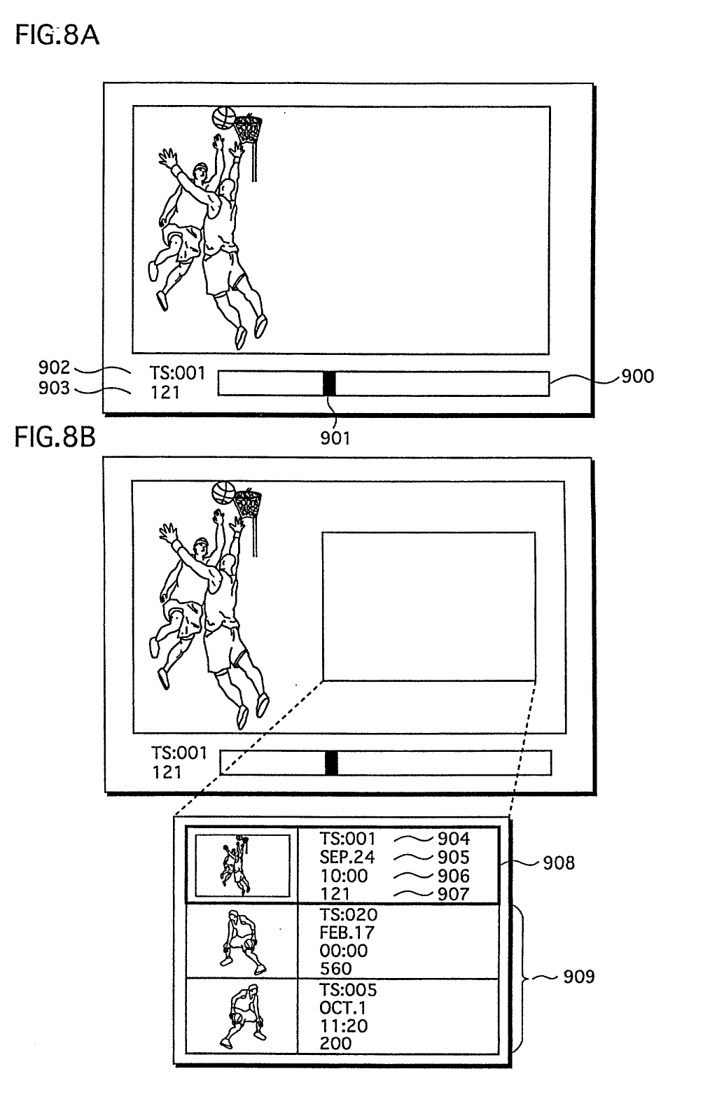

FIG. 8A shows an example of a screen displayed by the display unit 150 in step S603 in FIG. 6.

The figure shows a reproduction target scene being displayed on the screen and a bar 900 being displayed below, which indicates the time for the entire TS. On the bar 900, a mark 901 is displayed to indicate a location of data for the presently displayed scene on the time axis.

A field 902 shows a file name “001” of this TS, and a field 903 shows a program number “121” of a program including this scene.

FIG. 8B shows an example of a screen displayed by the display unit 150 in step S604 in FIG. 6.

A field 908 shows a scene that is presently specified and its transition information, whereas a field 909 shows previously registered transition information and its corresponding scene.

As described above, when a specification of a location of a transition target scene is received by the reception unit 102, not only the specified scene and its transition information but also previously registered transition information and its corresponding scene are displayed.

A field 904 shows a file name “001” of a file that stores a TS including this scene, a field 905 shows a date when this scene was recorded in the accumulated data reproduction apparatus 100 for the first time, a field 906 shows a time when this scene was recorded in the accumulated data reproduction apparatus 100 for the first time, and a field 907 shows a program number of a program including this scene.

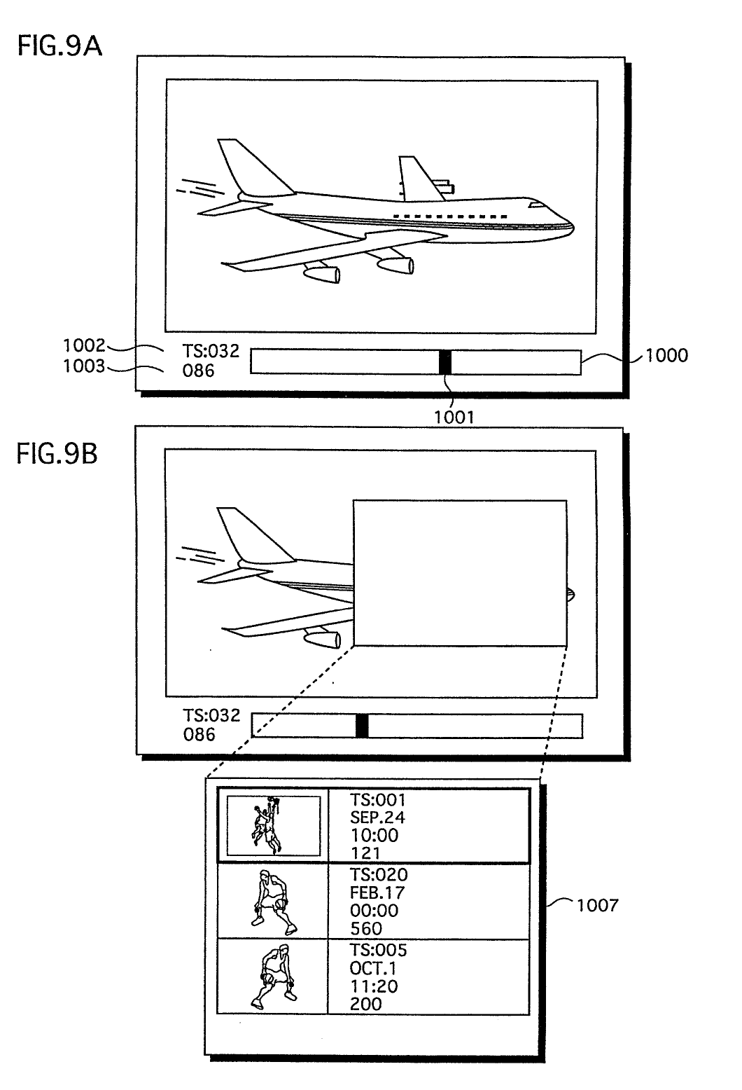

FIG. 9A shows an example of a screen displayed by the display unit 150 in step S607 in FIG. 6.

The figure shows a reproduction target scene being displayed on the screen and a bar 1000 being displayed below, which indicates the time for the entire TS. On the bar 1000, a mark 1001 is displayed to indicate a location of data for the presently displayed scene on the time axis.

A field 1002 shows a file name “032” of this TS, and a field 1003 shows a program number “086” of a program including this scene.

FIG. 9B shows an example of a screen displayed by the display unit 150 in step S608 in FIG. 6.

A field 1007 shows transition information that is generated when a transition target scene is specified, and the transition target scene.

The contents of the field 1007 are the same as those of the fields 908 and 909 in FIG. 8B.

In the figure, a bold frame is used for selecting a pair of transition information and a transition target scene. When a pair of transition information and a transition target scene is being selected using the bold frame, the selected pair can be specified by a determination operation.

As described above, the first embodiment of the present invention enables reproduction targets to be switched between different TSs during reproduction, by executing the data editing process. This further reduces the limitations of switchable reproduction targets during reproduction of programs in recorded TSs.

Also, by executing the data editing process only once, programs can be reproduced in the order selected by the user any number of times, thereby decreasing the trouble of selecting a TS and a program.

Although the first embodiment describes the case where the accumulated data reproduction apparatus 100 records an MPEG-2 TS, the present invention is also applicable to a prospective substitute for the MPEG-2 with the same data format as the MPEG-2 TS.

Also, although the first embodiment describes the case where the program information adjustment unit 115 stores the transition information into the above 1^{st} loop descriptor field 501, the program information adjustment unit 115 may store the transition information into one of 2^{nd} loop descriptor fields 504 included in so-called elementary information loops 511, 521, 531 each provided corresponding to one elementary stream.

Also, although the above field 903 shows the program number “121” of the program including this scene in FIG. 8A, it may show a channel number that can be recognized by the user more easily.

In this case, because one channel has a different program at a different time, one channel number needs to be associated with a plurality of program numbers. A functional unit for this association purpose needs to be additionally provided.

Also, although the first embodiment describes the case where the location of the transition target scene in the transition target program and the location of the transition source scene in the transition source program are specified, such specifications may be unnecessary in some cases, like when the reproduction target is to be switched at the end of one program to the start of another program.

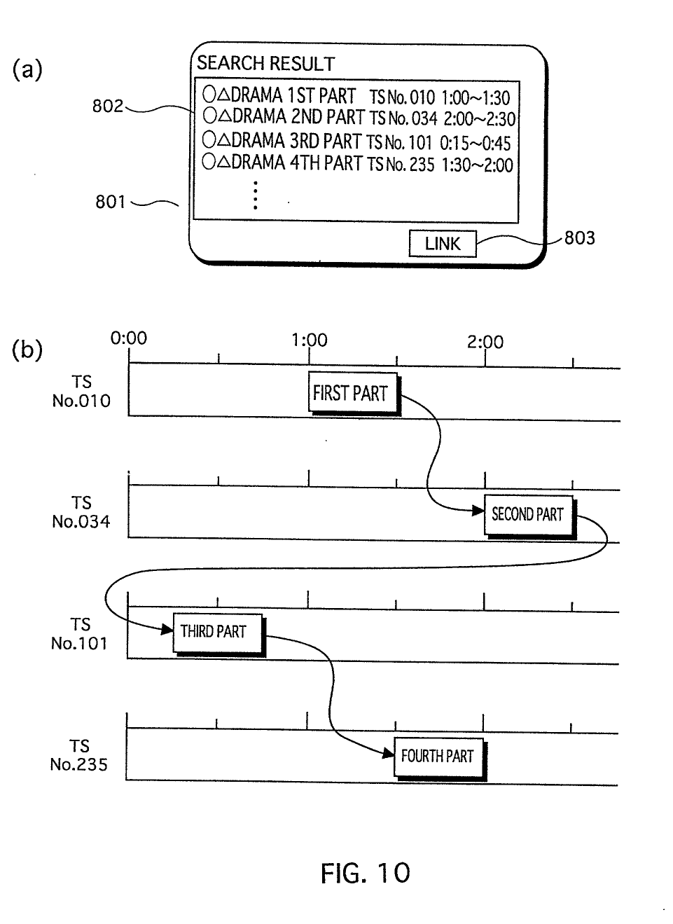

FIG. 10A shows an example of a screen for receiving an instruction from the user in the above mentioned case.

The following describes a case where program titles are associated with programs as data in program units and stored in the storage unit 101.

A field 802 shows a search result performed by the TS management unit 103 using a program title “◯Δ drama” as a key. It shows a file name of a file that stores a TS including each program and its broadcast time.

A link button 803 is for determining the reproduction order of programs as displayed from top to down in the field 802.

In this way, the data editing process may be executed based on information extracted using the program title as the key.

FIG. 10B shows a reproduction state when the above described data editing process has been executed.

In the figure, the horizontal axis indicates the time axis, and four bars arranged in the vertical direction each indicate a TS.

To sequentially reproduce a series of 1^{st} to 4^{th} programs of the ◯Δ drama, the reproduction target is switched from a program in one TS to a next program in another TS when each of the 1^{st} to 3^{rd} programs ends.

Although the first embodiment describes the case where reproduction targets are switched between programs included in different TSs, the reproduction target may be switched between programs included in a same TS at different locations on the time axis.

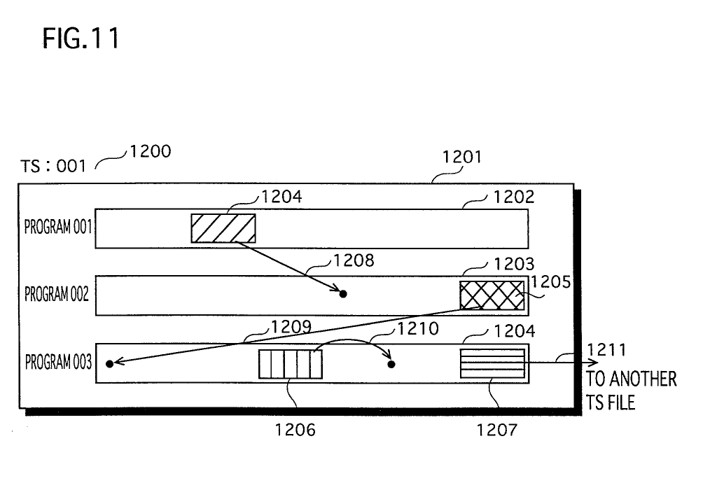

FIG. 11 shows an input screen for instructing switch of the reproduction target in the above described case.

In the figure, the horizontal axis indicates the time axis, and three bars arranged in the vertical direction each indicate a program.

A field 1200 shows a file name of a file that stores a TS.

A field 1201 shows three bars 1202, 1203, and 1204 that each indicate a time axis of a program included in the above TS. The bars 1202, 1203, and 1204 respectively include marks 1204, 1205, and 1206 and 1207, which each indicate a location where a PMT including the transition information is to be inserted.

With a drag operation, these marks 1204, 1205, 1206, and 1207 can be selected and moved. Furthermore, they can be deleted with a right-click, displayed with a left-click, so that the transition start location can be freely specified.

Also, arrows 1208, 1209, 1210, and 1211 are respectively extending from these marks. By positioning the tip of each arrow to a location on one of the bars, the location can be specified as the transition target.

Furthermore, by displaying the same field as the field 1200 for a different TS and by positioning the tip of the arrow 1211 to a location on a bar corresponding to a program in the different TS, the program in the different TS can also be specified as the transition target.

In the first embodiment, the transition information is inserted into a transition source TS with being stored in a PMT, but the transition information may be stored in a PAT of the transition source TS.

In this case, the PMT of the transition target program is not inserted into the transition source TS. The transition information extraction unit 117 refers to the PAT and judges whether the transition information is present or not. Also, no matter which program is being reproduced, a switch between reproduction targets is performed, upon referring to the above PAT.

Also, in this case, read data in the transition target TS is not reproduced from when the third program information extraction unit 108 extracts a PAT present in the transition target to when a PMT of a reproduction target program is extracted.

Also, in the first embodiment, the transition information generation unit 109 and the second program information extraction unit 107 each are internally provided with a storage medium such as a nonvolatile memory. The storage unit 101 may be used instead of the storage medium.

Also, the processing inverse to the data editing process may be performed on the TS on which the data editing process has been executed, to obtain the content of the PAT inserted in the data editing process and the PMT including the transition information. In this way, the TS on which the data editing process is yet to be executed can be restored.

<Second Embodiment>

The following describes a second embodiment of the present invention.

An accumulated data reproduction apparatus in the second embodiment has the same construction as the accumulated data reproduction apparatus 100 in the first embodiment, with the only difference being in some of the functional units being provided with additional functions.

Therefore, the second embodiment will be described, focusing only on the above difference from the first embodiment.

In the first embodiment, the reception unit 102 receives a specification of a location of the transition source scene in the transition source program in the TS(B) in the step S608 in FIG. 6 which shows the data editing process. In the second embodiment, however, the reception unit 102 receives an instruction indicating whether to perform the transition automatically or based on a user judgment (hereafter referred to as a “switch mode instruction”).

For this purpose, the transition information is additionally provided with a 1-bit flag for indicating the above switch mode instruction.

The switch mode instruction is sent from the reception unit 102 to the TS management unit 103, and from the TS management unit 103 to the program information adjustment unit 115. Accordingly, prior to the processing being executed in step S618 in FIG. 6, the program information adjustment unit 115 sets a value of the flag at “0” when the instruction to perform the transition automatically is given, and at “1” when the instruction to perform the transition based on the user judgment is given.

Before moving on to step S707 in FIG. 7, the transition information extraction unit 117 judges whether transition information is present in a PMT of the TS(a) received from the third program information extraction unit 108 as one example. When detecting the transition information in the PMT, the transition information extraction unit 117 judges whether the value of the flag is “0” or “1”.

When the value of the flag is judged to be “0”, the processing from step S707 is executed.

This appears to be the same operations as in the first embodiment.

On the other hand, when the value of the flag is judged to be “1”, the transition information extraction unit 117 makes the display unit 150 repeatedly display a presently displayed image, and the audio output unit 151 suspend to output audio.

The transition information unit 117 then instructs the display unit 150 to display buttons for allowing the user to input an instruction as to whether the reproduction target is to be switched or not.

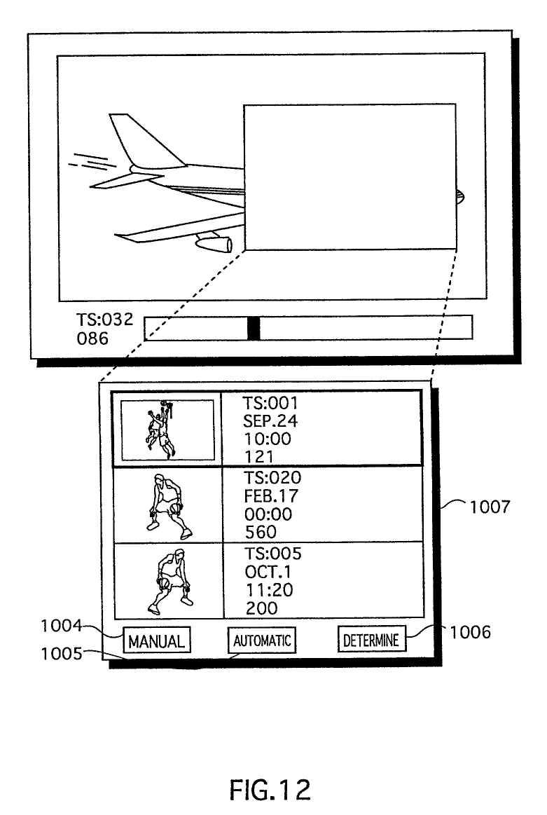

FIG. 12 shows a screen on which the above described buttons are displayed. This figure corresponds to FIG. 9B in the first embodiment.

A manual button 1004 is a button for instructing to perform the transition based on the user judgment.

An automatic button 1005 is a button for instructing to perform the transition automatically.

A determine button 1006 is for determining one of the above two instructions and for outputting the determined one of the instructions to the transition information extraction unit 117 via the TS management unit 103.

For this purpose, the TS management unit 103 has the function of outputting this instruction to the transition information extraction unit 117.

In the second embodiment, when an instruction to switch the reproduction target is inputted by the user, the processing from step S707 in FIG. 7 in the first embodiment, that is, the processing for switching the reproduction target is executed. On the other hand, when an instruction not to switch the reproduction target is inputted by the user, the processing from step S706 is executed.

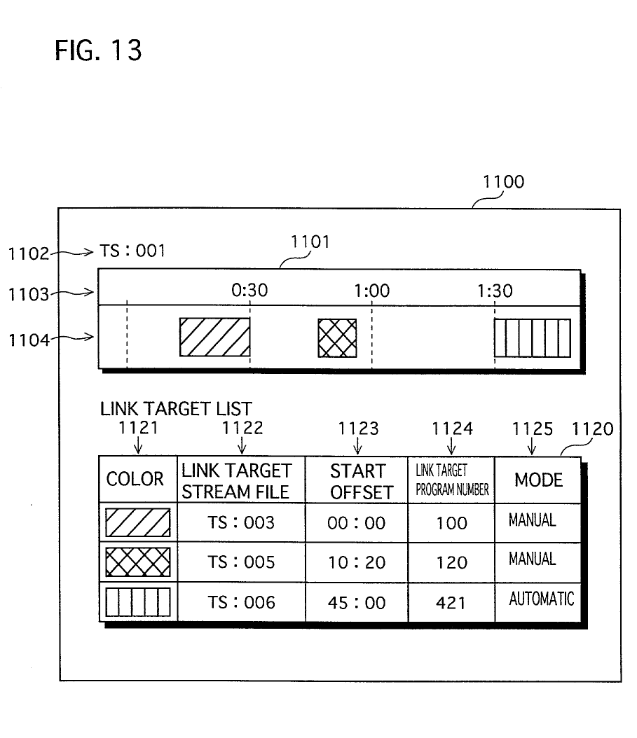

FIG. 13 is an example of a screen 1100 for receiving an instruction from the user.

A field 1102 shows a file name of a file that stores a TS to be edited.

A bar 1101 is an object for imagining the TS to be edited, the horizontal axis of which indicates a time axis.

Here, it is assumed that the TS includes only one program.

A line 1103 shows the time at which this TS has been recorded.

A line 1104 shows a data editing location indicated by each colored mark.

A link target list 1120 is a table showing a detailed content of transition information inserted at the data editing location.

A color field 1121 shows a color of the above mark.

A link target stream file field 1122 shows a file name of a file in which a transition target TS in transition reproduction is stored.

A start offset field 1123 shows a transition target location shown by the time on a time axis of a transition target TS.

A link target program number field 1124 shows a program number of a transition target program.

A mode field 1125 shows a switch mode instruction, where “automatic” setting indicates that the transition is performed automatically, and “manual” setting indicates that whether to perform the transition or not is determined based on a user judgment.

The screen 1100 described above enables the user to view the state of the data editing process on this TS and to alter the content of each field as necessary by manual input.

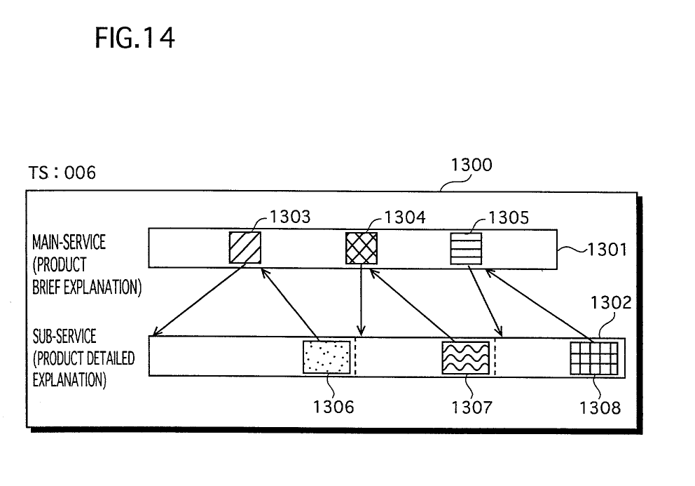

FIG. 14 shows examples of services offered using the accumulated data reproduction apparatus in the second embodiment.

In the figure, the horizontal axis indicates a time axis, and two bars arranged in the vertical direction each indicate a program.

A TS 1300 includes two programs 1301 and 1302.

Here, the program 1301 includes video, audio, and the like for briefly explaining a plurality of products, and a service offered by viewing this program is referred to as a main-service for convenience.

In the program 1301, three PMTs each including transition information are inserted.

Marks 1303, 1304, and 1305 with hatching respectively indicate locations at which the PMTs are inserted.

It is assumed that a value of a flag for each transition information is set at “1”, indicating the manual switch.

Also, the tip of an arrow extending from each mark points to a transition target location.

A program 1302 includes video, audio, and the like for explaining the plurality of products in detail, and a service offered by viewing this program is referred to as a sub-service for convenience.

In the program 1302, too, three PMTs each including transition information are inserted.

Marks 1306, 1307, and 1308 with hatching respectively indicate locations at which the PMTs are inserted.

It is assumed that a value of a flag for each transition information is set at “0”, indicating the automatic switch.

In the program that offers the main-service, when video data and audio data present at the location of the mark 1303 are reproduced, a message is displayed inquiring the user whether to switch the reproduction target to a program that offers the sub-service.

Here, when the user who has viewed a brief explanation of a product desires to view a more detailed explanation of the product, the user gives an instruction to switch the reproduction target.

When an input of this instruction is given, the reproduction target is switched to the program that offers the sub-service.

A PMT including the transition information is inserted at a location where this detailed explanation ends. When the program 1302 is reproduced until this location, the reproduction target is automatically switched to a location immediately following the mark 1303 in the program 1301 that offers the main-service.

By repeatedly performing such a switch between two programs, flexible services that satisfy user requests can be provided.

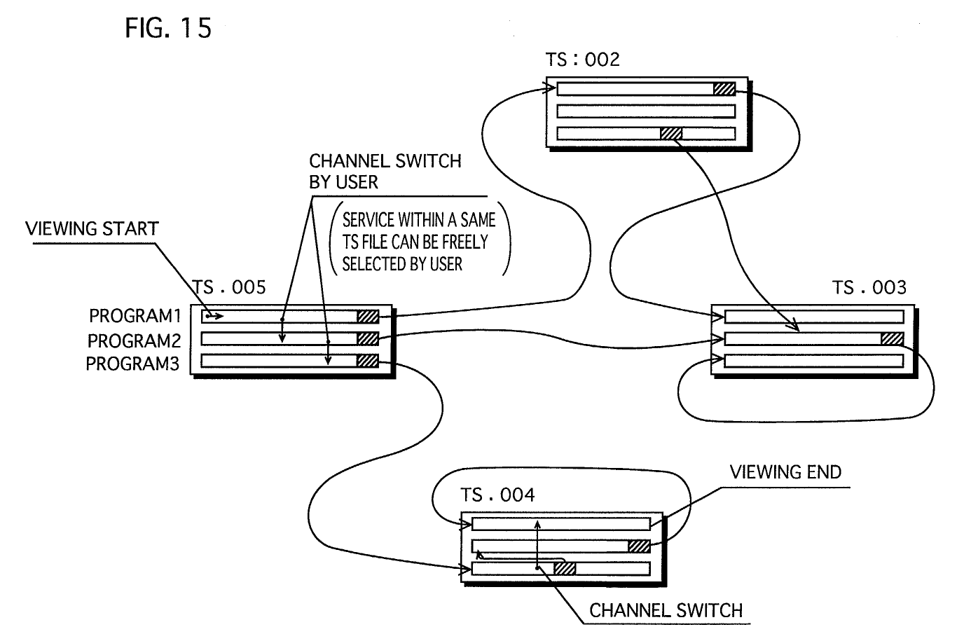

FIG. 15 shows examples of services offered using the accumulated data reproduction apparatus in the second embodiment.

In the figure, the horizontal axis indicates a time axis, and four large bars at top, bottom, left, and right each indicate a TS. Three bars included in each TS each indicate a program.

The user can switch the reproduction target freely to another program included in a TS to which a presently reproduced program belongs.

This switch is performed in the same manner as a channel switch in the normal broadcasting, and locations on a time axis in a transition target TS match locations on a time axis in a transition source TS.

In each program, a PMT including transition information is inserted. The transition information indicates a program in a different TS or another program in the same TS as a transition target.

With this data structure, combining the program switch by the user and the reproduction target switch by the transition information yields a so-called multi-story, in which different programs are eventually reproduced depending on the user.

As described above, according to the second embodiment, the value of the flag included in the transition information is set at “1” in the data editing process. Due to this, when the PMT is detected by the transition information extraction unit 117, the buttons are displayed for allowing the user to input an instruction as to whether the reproduction target is to be switched or not, and reproduction in accordance with the instruction input is performed. This further reduces the limitations of switchable reproduction targets during reproduction of programs in recorded TSs.

Also, as in the first embodiment, the transition information generation unit 109 in the second embodiment stores three items, namely, a count value, a file name, and a program number, as one set of transition information. However, other items may also be included in the set of transition information.

As one example, in the case where a transition target TS shown by the above set of transition information includes other sets of transition information as is the case in FIG. 14, a plurality of brief product explanations and detailed product explanations can be viewed continuously, by sequentially switching the reproduction targets using these sets of transition information. These product explanations viewed continuously can be considered as one reproduction unit. A plurality of sets of transition information included in the TS that belongs to this reproduction unit are categorized in the same group. Here, the transition information generation unit 109 may add a group number for identifying this group, as a new item in each set of the transition information.

In this case, the group number may be inputted by the user via the reception unit 102. Alternatively, in a case where the program information adjustment unit 115 inserts transition information in the TS with being included in a PMT, a group number identical to the group number included in the transition information indicating the insertion target TS may be generated.

Also, as one example, this group number may be displayed in a field provided at right of the mode field 1125 in the link target list 1120 in FIG. 13.

Also, it is needless to say that this group information should not be limited to the group number, but any information that can identify the group, such as an alphabet or a symbol, can be used.

<Third Embodiment>

The following describes a third embodiment of the present invention.

An accumulated data reproduction apparatus in the third embodiment has the same construction as the accumulated data reproduction apparatus 100 in the first embodiment, with the only difference being in the function of the program information adjustment unit.

Therefore, the third embodiment will be described, focusing only on the above difference from the first embodiment.

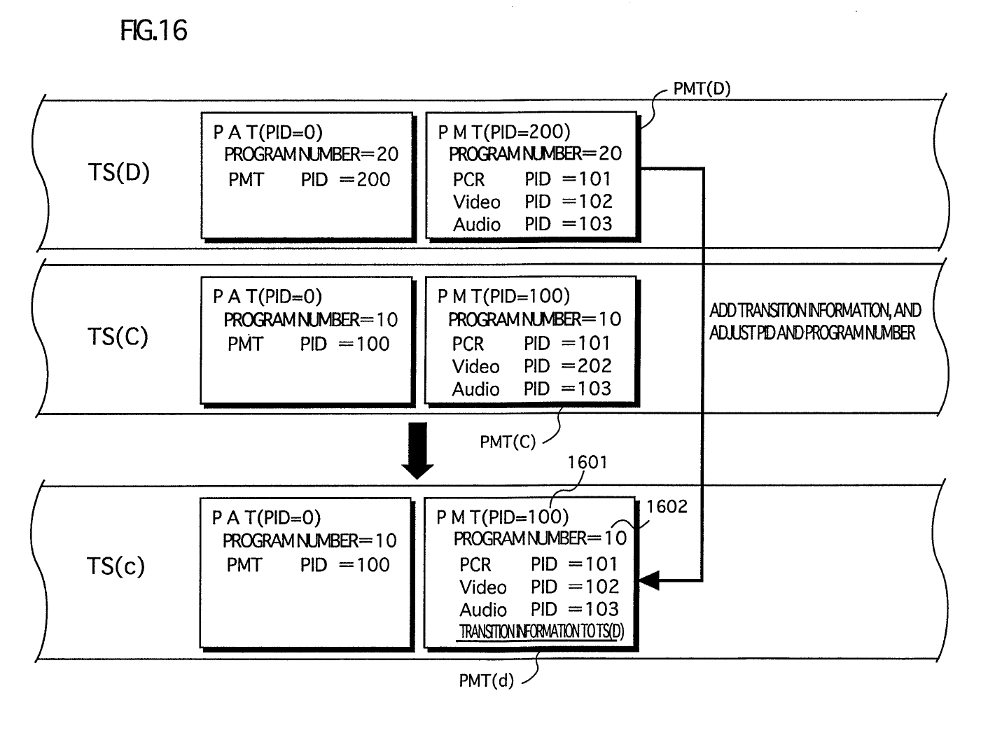

FIG. 16 shows the content of data editing performed by the program information adjustment unit in the third embodiment.

A TS(C) is a transition source TS, a TS(D) is a transition target TS, and a TS(c) is an edited TS obtained by executing the data editing process on the TS(C).

In the first embodiment, the program information adjustment unit 115 changes the content of a PAT of the transition target TS. In the third embodiment, however, the PAT of the transition target TS is kept intact.

Also, in the first embodiment, a PMT originally present in the transition source TS is kept intact. In the third embodiment, however, a PMT present at a location following the transition start location in the transition source program is deleted, and a transition PMT is inserted to replace the deleted PMT.

Here, in the first embodiment, a program number of a program to be added is changed so that program numbers used in the transition source TS do not match the program number of the transition target program, and a PID of a transition PMT is changed so that all PIDs used in the transition source TS do not match the PID of the transition PMT. In the third embodiment, however, the program information adjustment unit changes the PID value of the transition PMT to the PID value of the deleted PMT, and changes the program number shown in the transition PMT to the program number shown in the deleted PMT.

To be more specific, the PMT in the TS(C) is replaced by the transition PMT, so that the number of programs in the TS(C) appears as the same.

The PMT(C) shown in FIG. 16 is the above described PMT to be deleted, and the PMT(d) is the transition PMT in which the above change has been performed.

Note that the transition PMT includes transition information as in the first embodiment.

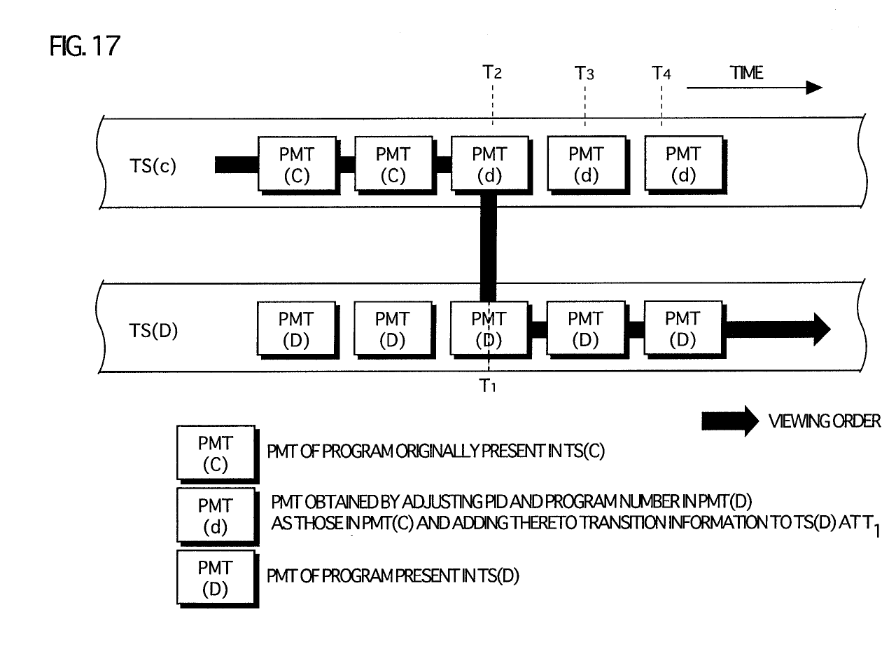

FIG. 17 shows a location of the originally present PMT(C) and a location of the newly added PMT(d) in the TS(c) on which the data editing process has been executed.

The transition start location in the transition source TS is supposed to be the location “T2” in FIG. 17. However, taking the possibility of skipping to read the transition PMT into consideration, the transition PMT is inserted not only at the location “T2” but also at the locations “T3” and “T4”.

Also, the third embodiment differs from the first embodiment in that PIDs of all the packets included in the TS(C) do not need to be referred to and so the packet ID detection unit 112 does not need to be provided, since the PID value of the transition PMT is the same as the PID value of the PMT corresponding to the program present in the TS(C) in the third embodiment.

As described above, the third embodiment of the present invention enables reproduction targets to be switched between different TSs during reproduction, by executing the data editing process as the first embodiment. This further reduces the limitations of switchable reproduction targets during reproduction of programs in recorded TSs.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is

1. A data reproduction apparatus that reproduces data included in transport streams, comprising:
a storage medium storing a first transport stream that includes location information at a first location thereof, the location information identifying a second location that is on a time axis and that differs from the first location, the second location being included in the first transport stream or in a second transport stream; and
reproduction means for
(a) reproducing video data and/or audio data included in a reference target in the first transport stream, while shifting the reference target along a time axis of the first transport stream, and
(b) switching the reference target to the second location identified by the location information, when the reference target in the first transport stream includes the location information.

2. The data reproduction apparatus of claim 1,
wherein the storage medium stores the second transport stream that includes the second location,
the location information further includes transport stream information that identifies the second transport stream that includes the second location, and
the reproduction means switches the reference target to the second location in the second transport stream identified by the transport stream information.

3. The data reproduction apparatus of claim 2,
wherein each of the first and second transport streams includes data for a plurality of programs with being multiplexed,
the location information further includes program ID information that identifies one of the plurality of programs, and
the reproduction means sets, as the reference target, video data and/or audio data that belongs to the program identified by the program ID information and that is present at and following the second location, after switching the reference target.

4. The data reproduction apparatus of claim 3,
wherein each of the first and second transport streams is composed of a plurality of packets and includes a program map table for identifying data that constitutes each program included therein, and a program association table for identifying a packet that carries the program map table, and
the location information is included in the program map table.

5. The data reproduction apparatus of claim 4,
wherein the program map table that includes the location information identifies data for the program identified by the program ID information.

6. The data reproduction apparatus of claim 5, further comprising
location information insertion means for
(a) extracting a program map table for identifying the program identified by the program ID information from the second transport stream,
(b) adding the location information to the extracted program map table, to generate an insertion program map table, and
(c) inserting the generated insertion program map table into a transport stream to generate the first transport stream,
wherein the program map table including the location information included in the first transport stream is the insertion program map table that has been inserted by the location information insertion means.

7. The data reproduction apparatus of claim 6,
wherein when inserting the insertion program map table including the location information, the location information insertion means
(a) deletes a program map table of a program to be referred to before switching the reference target,
(b) changes a value of a packet identifier of the insertion program map table to a value of a packet identifier of the deleted program map table, and
(c) changes a program number shown in the insertion program map table to a program number shown in the deleted program map table.

8. The data reproduction apparatus of claim 6,
wherein the insertion program map tale includes a program number of the program identified by the program ID information and a packet identifier for identifying a program map table corresponding to the program identified by the program ID information, and
the location information insertion means further adds the program number and the packet identifier to a program association table present in a vicinity preceding a location at which the insertion program map table has been inserted.

9. The data reproduction apparatus of claim 8,
wherein the location information insertion means,
(a) before adding the program number and the packet identifier to the program association table,
replaces the program number with a unique number, if the program number is already present in the program association table, and
replaces the value of the packet identifier with a unique value, if the value of the packet identifier is already used in the transport stream into which the insertion program map table is yet to be inserted, and
(b) before inserting the insertion program map table,
replaces the program number included in the insertion program map table with the unique number, if the program number added to the program association table has been replaced with the unique number, and
replaces the value of the packet identifier included in the insertion program map table with the unique value, if the value of the packet identifier added to the program association table has been replaced with the unique value.

10. The data reproduction apparatus of claim 3,
wherein each of the first and second transport streams is composed of a plurality of packets and includes a program map table for identifying data that constitutes each program included therein, and a program association table for identifying a packet that carries the program map table, and
the location information is included in the program association table.

11. The data reproduction apparatus of claim 2,
wherein the transport stream information is a name of a file that stores the second transport stream in the storage medium.

12. The data reproduction apparatus of claim 3,
wherein each of the first and second transport streams includes a packet that carries a program map table for identifying data that constitutes each program included therein, and a program association table for identifying the packet that carries the program map table, and
the program ID information is a program number shown in the program association table and in the program map table.

13. The data reproduction apparatus of claim 1, further comprising
location information insertion means for inserting the location information into a transport stream to generate the first transport stream,
wherein the location information included in the first transport stream has been inserted by the location information insertion means.

14. The data reproduction apparatus of claim 13, further, comprising
insertion location obtaining means for obtaining the first location and notifying the location information insertion means of the obtained first location.

15. The data reproduction apparatus of claim 13, further comprising:
display means for displaying on a screen a plurality of locations as candidates for the first location; and
reception means for receiving a specification of one of the plurality of locations,
wherein the location information insertion means inserts the location information into the transport stream at the one of the locations specified as the first location.

16. The data reproduction apparatus of claim 15,
wherein the location information further includes mode information indicating one of a manual mode and an automatic mode, the manual mode for switching the reproduction target by a user judgment, the automatic mode for switching the reproduction target without the user judgment, and
the reproduction means switches the reproduction target based on the mode information.

17. The data reproduction apparatus of claim 16,
wherein the reception means further receives a specification of one of the manual mode and the automatic mode, and
the location information insertion means inserts the location information provided with the mode information indicating the specified mode.

18. The data reproduction apparatus of claim 17,
wherein the reception means further receives, from the user, a display instruction to display a specification state of the mode, and
the display means displays information associating the location information with the mode when receiving the display instruction.

19. The data reproduction apparatus of claim 13, further comprising:
reception means for receiving an instruction from a user; and
restoration means for obtaining, when receiving a restoration instruction to restore the transport stream into which the location information is yet to be inserted, the location information inserted by the location information insertion means from the first transport stream, and restoring the transport stream into which the location information is yet to be inserted.

20. The data reproduction apparatus of claim 1, further comprising
reception means for receiving an instruction from a user,
wherein the reproduction means switches the reproduction target only when an instruction to switch the reproduction target from the user is received by the reception means.

21. The data reproduction apparatus of claim 20, further comprising
display means for displaying information for having the user input an instruction indicating whether to switch the reproduction target or not, when the reference target includes the location information.

22. The data reproduction apparatus of claim 21, further comprising
location information insertion means for inserting the location information into a transport stream to generate the first transport stream,
wherein the location information included in the first transport stream has been inserted by the location information insertion means.

23. The data reproduction apparatus of claim 1, further comprising:
second location obtaining means for obtaining the second location on the time axis; and
location information generation means for generating the location information based on the second location obtained by the second location obtaining means,
wherein the location information included in the first transport stream has been generated by the location information generation means.

24. The data reproduction apparatus of claim 1,
wherein each of the first and second transport streams is composed of a plurality of packets, and
the location information is a number of packets present between a first packet and a packet at the second location inclusive, in the transport stream.

25. A data reproduction apparatus that reproduces data included in data streams, comprising:
a storage medium storing a first data stream that includes location information at a first location thereof, the location information identifying a second location that is on a time axis and that differs from the first location, the second location being included in the first data stream or in a second data stream; and
reproduction means for
(a) reproducing video data and/or audio data included in a reference target in the first data stream, while shifting the reference target along a time axis of the first data stream, and
(c) switching the reference target to the second location identified by the location information, when the reference target in the first data stream includes the location information.

26. A data reproduction method for use in a data reproduction apparatus that reproduces data included in transport streams and that includes a storage medium storing a first transport stream that includes location information at a first location thereof, the location information identifying a second location that is on a time axis and that differs from the first location, the second location being included in the first transport stream or in a second transport stream, the data reproduction method including
a reproduction step for
(a) reproducing video data and/or audio data included in a reference target in the first transport stream, while shifting the reference target along a time axis of the first transport stream, and
(b) switching the reference target to the second location identified by the location information, when the reference target in the first transport stream includes the location information.

27. A computer-readable recording medium on which a program for making a data reproduction apparatus reproduce data is recorded, the data reproduction apparatus reproducing data included in transport streams and including a storage medium storing a first transport stream that includes location information at a first location thereof, the location information identifying a second location that is on a time axis and that differs from the first location, the second location being included in the first transport stream or in a second transport stream, the program including
a reproduction step for
(a) reproducing video data and/or audio data included in a reference target in the first transport stream, while shifting the reference target along a time axis of the first transport stream, and
(b) switching the reference target to the second location identified by the location information, when the reference target in the first transport stream includes the location information.

28. A data editing apparatus that edits transport streams, comprising:
a storage medium; and
editing means for
(a) editing a transport stream by inserting location information into the transport stream at a first location thereof, the location information identifying a second location that is on a time axis and that differs from the first location, the second location being included in the transport stream into which the location information has been inserted, or in a different transport stream, and
(b) storing the edited transport stream into the storage medium.
